(19) United States
(12) Patent Application Publication
(10) Pub. No.: US 2016/0304210 A1
(43) Pub. Date: Oct. 20, 2016

(54) ONE-PIECE AIR DATA PROBE

(71) Applicant: Rosemount Aerospace Inc., Burnsville, MN (US)

(72) Inventors: William Louis Wentland, Rockford, IL (US); Eric Karlen, Rockford, IL (US); Matthew P. Anderson, Burnsville, MN (US)

(21) Appl. No.: 14/514,462

(22) Filed: Oct. 15, 2014

(51) Int. Cl. B64D 15/12; G01P 5/165; B64D 15/22; B33Y 70/00; B33Y 80/00

(52) U.S. Cl. CPC B64D 15/12; B33Y 70/00; B33Y 80/00; B64D 15/22; G01P 5/165

(57) ABSTRACT

A method of forming an air data probe comprises the steps of utilizing an additive manufacturing technique to lay down a portion of a wall of an air data probe, and also utilizing an additive manufacturing technique to lay down a conductive portion of a heater element within the wall. An air data probe is also disclosed.

### BACKGROUND OF THE INVENTION

This application relates to an air data probe for use in aircraft applications and wherein electrical heater elements are imbedded in a wall of the probe.

Modern aircraft are becoming more sophisticated and require precise information. Controls for modern aircraft must know an air speed with accuracy. As part of determining the air speed, an air data probe is often mounted at a location on an aircraft body.

Modern air data probes take in air and evaluate that air to determine air speed and other parameters (as examples, altitude, angle of attack, angle of side slip) of an aircraft carrying the probe. One challenge is that aircraft often operate in extremely cold environments.

As such, air data probes are often provided with heater elements. Standard air data probes as manufactured will typically include an outer wall formed of a metal. The heater elements are then mounted within an inner periphery of that wall. Of course, mounting the heater elements within the inner periphery spaces them away from the outer surface of the air data probe.

It has been proposed to cast heater elements within a body of an air data probe. However, casting processes may result in degradation of the heater assembly. In addition, a dielectric material and casing is often placed between the electric heater element and the material forming the wall separated by the casing. The dielectric material and casing may also be subject to degradation from casting processes.

### SUMMARY OF THE INVENTION

A method of forming an air data probe comprises the steps of (1) utilizing an additive manufacturing technique to lay down a portion of a wall of an air data probe, and (2) also utilizing an additive manufacturing technique to lay down a conductive portion of a heater element within the wall. An air data probe is also disclosed.

These and other features may be best understood from the following drawings and specification.

### BRIEF DESCRIPTION OF THE DRAWINGS

FIG. 1 shows an air data probe mounted on an aircraft.

FIG. 2A shows a first step in forming the air data probe.

FIG. 2B shows a subsequent step.

FIG. 2C shows a portion of the air data probe as manufactured.

### DETAILED DESCRIPTION

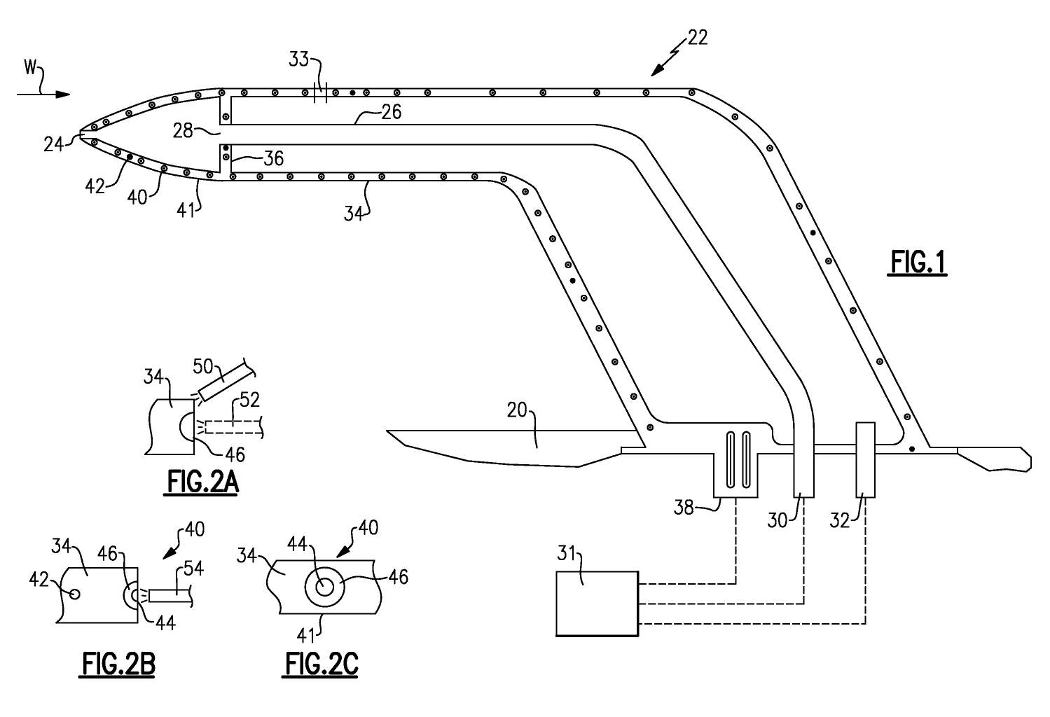

FIG. 1 shows an aircraft body 20, schematically. An air data probe 22 is mounted to the aircraft body. The air data probe 22 has a tap 24 at a forward end. The tap 24 will sample a portion of air W as the aircraft moves through the air. The tapped air will move into an opening 28 in a tube 26, and to a pitot pressure tap 30. Pressure tap 30 is shown communicating with a control 31. Control 31 will translate the tapped pressure into an air speed of the aircraft body 20. In addition, a static pressure tap 32 is utilized and communicates to the control 31. A hole 33 provides a tap to communicate air to static pressure tap 32. The details for translating tapped pressures into an air speed may be as known and form no portion of this disclosure.

A wall 34 of the air data probe is formed, as is a forward boss 36 receiving the tube 26. An electric heater connection 38 communicates to the control 31 and provides electric power to heater elements 40. In addition, sensors 42 may be imbedded within the wall 34. The sensors 42 may be temperature sensors, as an example. The temperature sensors 42 also communicate back to the control 31. The heater elements 40 are provided with electric current to generate heat and are imbedded within the wall 34. As such, the heater elements 40 are closer to an outer periphery 41 of the air data probe 22 than has been the case in the traditional air data probe.

The sensor 42 will communicate a temperature of the wall 34, as an example, to the control 31. The control 31 can, thus, control the current supplied to the heater element 40 based upon the sensed temperature and to ensure proper operation.

FIGS. 2A and 2B show a method of forming the air data probe 22. So-called “additive manufacturing” techniques are utilized to form the air data probe 22 and the embedded elements 40 and sensors 42. While any number of additive manufacturing techniques may be utilized, additive manufacturing techniques as suggested to form structure of appropriate wall material that is a good temperature conductor, as well as depositing the electric elements 40 and 42. Typically, metal is utilized for wall 34 and boss 36, as well as the electric components 40 and 42.

Laser engineered net shaping additive manufacturing techniques may be utilized. Laser sintering or powder feed technology may be utilized. Alternatively, a laser may be utilized to melt wire to form the electric conductor and sensor portions 40 and 42. Other additive manufacturing techniques, such as electron beam melting may also be used.

As shown in FIG. 2A, a portion of the wall 34 is being formed by an additive manufacturing tool 50. Another tool 52 is shown in phantom and deposits a dielectric material. The tools 50 and 52 may be a single additive manufacturing tool and simply, the feed to a laser, which forms a portion of these tools, may differ when the wall 34 is being formed as compared to the material 46. The dielectric material insulates a conductor portion of the heater element 40.

As shown in FIG. 2B, another tool 54 may deposit a conductor portion 44 of the heater element 40. Again, a laser may be utilized as a portion of the tool 54 and a single laser may be utilized for each of the tools 50, 52 and 54, with the feeds to the lasers being simply changed between materials.

In addition, as shown in FIG. 2B, the sensor 42 may have previously been formed in a similar manner.

FIG. 2C shows the final wall 34 having the heater element 40 with an inner electric conductor portion 44 and a dielectric material 46. The dielectric material serves to electrically insulate the conductor 44, but preferably is a good transmitter of heat, such that the heat from the conductor 44 reaches the outer surface 41 of the wall 34. Tube 26 and boss 36 are formed in a similar manner, and from the same material as wall 34.

With the disclosed embodiment, a one-piece air data probe provides better operational features than the prior art.

Although an embodiment of this invention has been disclosed, a worker of ordinary skill in this art would recognize that certain modifications would come within the scope of this invention. For that reason, the following claims should be studied to determine the true scope and content of this invention.

1. A method of forming an air data probe comprising the steps of:
(a) utilizing an additive manufacturing technique to lay down a portion of a wall of an air data probe; and
(b) also utilizing an additive manufacturing technique to lay down a conductive portion of a heater element within the wall.

2. The method as set forth in claim 1, wherein the method further includes the step of utilizing an additive manufacturing technique to lay down a dielectric material that insulates the conductive portion from the wall.

3. The method as set forth in claim 2, wherein said wall is formed of a metal.

4. The method as set forth in claim 2, wherein said additive manufacturing techniques include the use of a laser.

5. The method as set forth in claim 4, wherein said laser utilizes laser powder feed technology.

6. The method as set forth in claim 4, wherein sensors are also formed within said wall by additive manufacturing techniques.

7. The method as set forth in claim 2, wherein a tube is also formed to communicate a tapped air pressure from a forward end of said air data probe to a location outwardly of said air data probe.

8. The method as set forth in claim 7, wherein said tube is also formed by additive manufacturing techniques.

9. The method as set forth in claim 8, wherein said tube is formed of the same material as said wall.

10. The method as set forth in claim 1, wherein said additive manufacturing techniques include the use of a laser.

11. The method as set forth in claim 1, wherein sensors are also formed within said wall by additive manufacturing techniques.

12. An air data probe comprising:
a wall, a boss extending across a hollow interior of said wall, an opening formed at a forward end of said wall to provide an air tap, and said opening communicating to an opening in a tube mounted within said boss, and said tube extending to an outer end of said air data probe; and
at least said wall being formed with a heater element and at least one temperature sensor, with said temperature sensor and said heater element being imbedded in said wall.

13. The air data probe as set forth in claim 12, wherein said air data probe, including said sensors and said heater elements are formed by additive manufacturing techniques.

14. The air data probe as set forth in claim 12, wherein said heater elements are provided with an insulating dielectric material to insulate a conductor portion of said heater element from said wall.

15. The air data probe as set forth in claim 12, wherein said wall, said boss and said tube are formed of a metal.
